(19) United States
(12) Patent Application Publication
(10) Pub. No.: US 2011/0080256 A1
(43) Pub. Date: Apr. 7, 2011

(54) VEHICLE ACCESS SYSTEM

(76) Inventor: George M. Mehalshick, SR., Hazelton, PA (US)

(21) Appl. No.: 12/896,765

(22) Filed: Oct. 1, 2010

Related U.S. Application Data
(60) Provisional application No. 61/248,287, filed on Oct. 2, 2009.

(51) Int. Cl. G06F 7/04

(52) U.S. Cl. 340/5.7

(57) ABSTRACT

An access control system includes an access database and barrier controller in communication with the access database. The access control system includes a vehicle with an electrical system having an OBD transceiver in communication with an on-board computer through an OBD connector. The OBD transceiver provides a vehicle indication signal S_{Vehicle} to the barrier controller in response to receiving a query signal S_{Query} from the barrier controller.

### CROSS-REFERENCE TO RELATED APPLICATIONS

This application claims priority to U.S. Provisional Application No. 61/248,287, filed on Oct. 2, 2009, by the same inventor, the contents of which are incorporated by reference as though fully set forth herein.

### BACKGROUND OF THE INVENTION

1. Field of the Invention

This invention relates generally to controlling vehicle access using data processing.

2. Description of the Related Art

It is highly desirable to control access to certain areas for security reasons. For example, some buildings includes security devices, such as a security barrier, which restrict the access of vehicles. Examples of security barriers which restrict the access of vehicles are disclosed in U.S. Pat. Nos. 4,600,335, 4,665,395, 4,711,608, 4,919,563, 5,136,548, 7,048,467 and 7,101,112, the contents of which are incorporated by reference as though fully set forth herein. However, it is desirable to provide more secure access, and to log failed access attempts.

### BRIEF SUMMARY OF THE INVENTION

The present invention is directed to a vehicle access control system, as well as a method of installing and operating the vehicle access control system. The novel features of the invention are set forth with particularity in the appended claims. The invention will be best understood from the following description when read in conjunction with the accompanying drawings.

### BRIEF DESCRIPTION OF THE DRAWINGS

FIGS. 1a and 1b are perspective views of an access control system.

FIG. 1c is a block diagram of the access control system of FIGS. 1a and 1b.

FIG. 2a is a perspective view of the one embodiment of barrier controller of the access control system of FIGS. 1a and 1b.

FIG. 2b is a perspective view of the barrier controller of FIG. 2a.

FIG. 2c is a block diagram of the barrier controller of FIG. 2a.

FIG. 3 is a block diagram of one embodiment of an electrical system of the vehicle shown in FIG. 1a.

FIGS. 4a and 4b are perspective views of an interior of the vehicle shown in FIG. 1a.

FIG. 4b is a perspective view of an interior of vehicle 100, which shows OBD connector 114 positioned proximate to vehicle door 111 and fuse panel 112.

FIGS. 5a and 5b are perspective and end views, respectively, of an OBD connector shown in FIGS. 4a and 4b.

FIG. 6 is a perspective view of the OBD transceiver of FIGS. 5a and 5b.

FIGS. 7a and 7b are perspective and side views, respectively, of the OBD transceiver of FIGS. 5a and 5b.

FIG. 8 is a block diagram of the electrical system of the vehicle of FIG. 1a in communication with the barrier controller of FIG. 1a through a wireless link.

FIGS. 9a, 9b and 9c are front view of a display of FIG. 2a.

FIG. 10 is an embodiment of an access control system with a barrier embodied as a gate.

FIG. 11 is an embodiment of an access control system with a barrier embodied as a ramp.

FIG. 12 is a flow diagram of one embodiment of the operation of access control system 100.

### DETAILED DESCRIPTION OF THE INVENTION

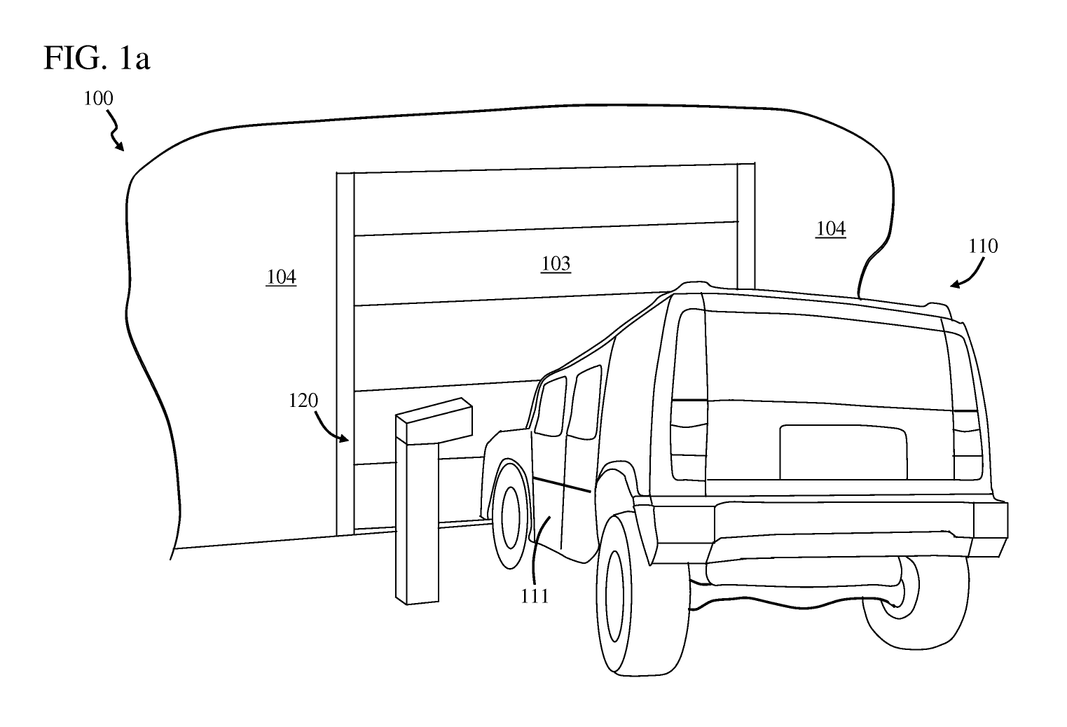

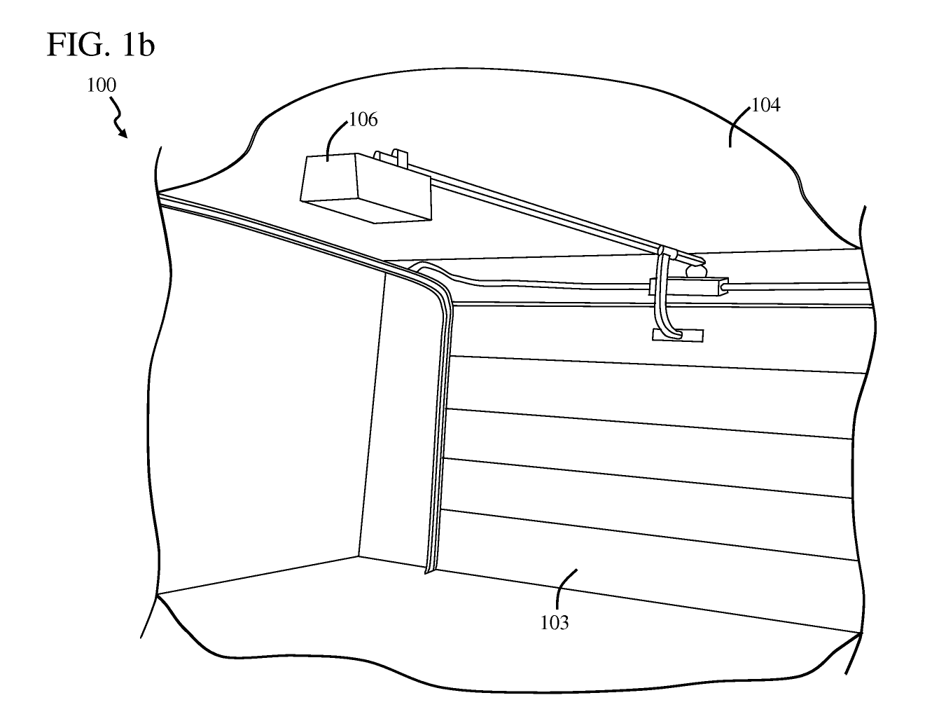

FIGS. 1a and 1b are perspective views of an access control system 100, and FIG. 1c is a block diagram of access control system 100. In this embodiment, access control system 100 controls access to an area, which is embodied as a building 104. However, it should be noted that access control system 100 can control access to many other areas, such as a garage, home and parking lot, among others. In general, access control system 100 controls access of a vehicle 110 to an area it is desired to control access to.

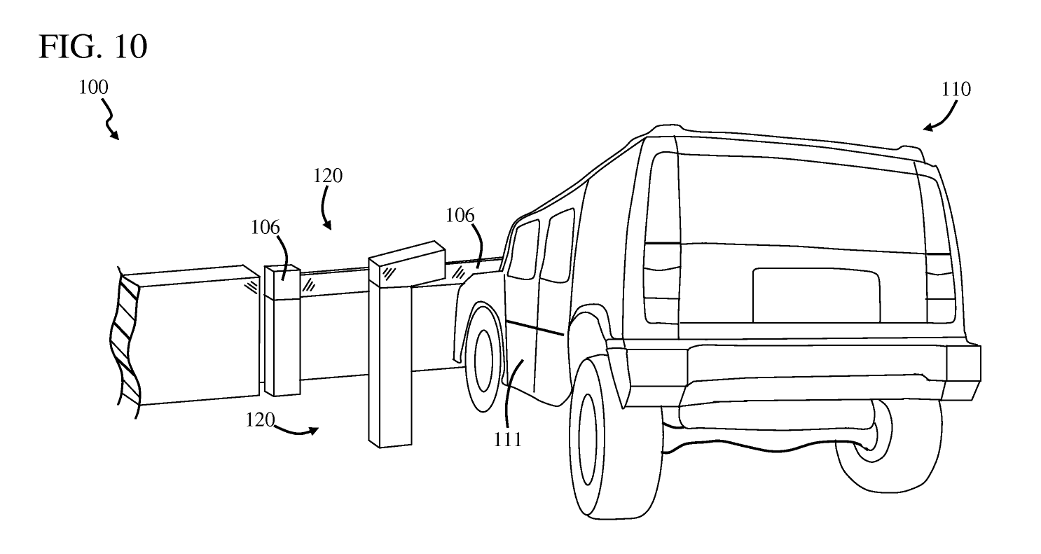

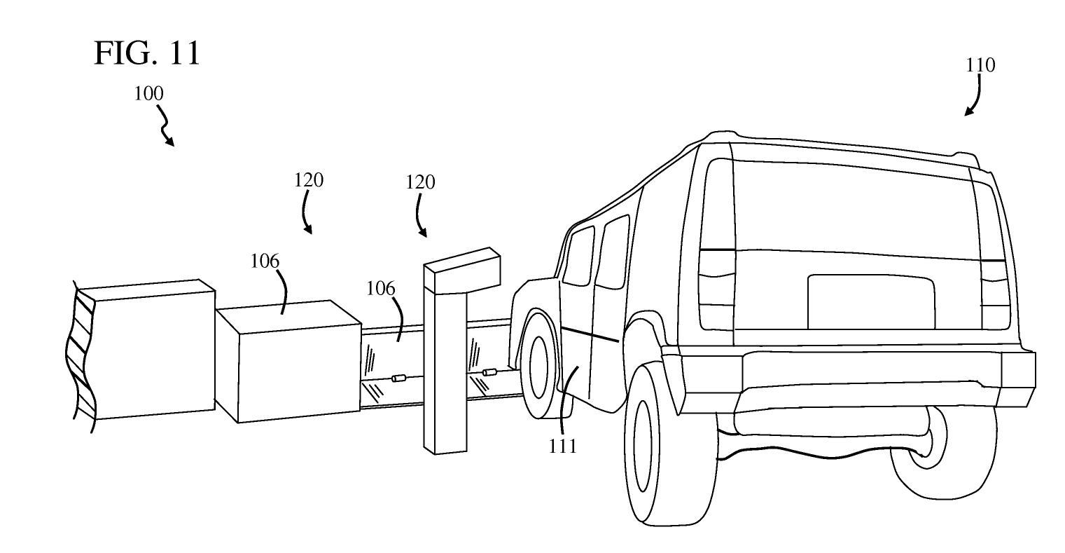

In this embodiment, access control system 100 controls access to the area by controlling the operation of a barrier. The barrier can be of many different types, such as a gate, barrier gate, door, ramp and fence, among others. Examples of different types of barriers are disclosed in U.S. Pat. Nos. 4,600,335, 5,748,101 and 6,157,314, the contents of which are incorporated by reference as though fully set forth herein. An embodiment of access control system 100 with a barrier embodied as a gate is shown in FIG. 10 and an embodiment of access control system 100 with a barrier embodied as a ramp is shown in FIG. 11.

In the embodiment of FIGS. 1a and 1b, the barrier is embodied as an overhead door 103. Overhead door 103 is repeatably moveable between raised and lowered positions, wherein overhead door 103 is shown in the lowered position in FIGS. 1a and 1b. Overhead door 103 is operatively coupled to an overhead door operator 106, which is shown in FIG. 1b. Overhead door 103 moves between the raised and lowered positions in response to operation of overhead door operator 106. In particular, overhead door 103 moves between the raised and lowered positions in response to a operator indication signal S_{Operator} (FIG. 1c) provided by overhead door operator 106.

In one situation, overhead door 103 moves from the lowered position to the raised position in response to receiving operator indication signal S_{Operator} from overhead door operator 106. Operator indication signal S_{Operator} corresponds to an open indication when overhead door 103 moves from the lowered position to the raised position in response to receiving operator indication signal S_{Operator} from overhead door operator 106.

In another situation, overhead door 103 remains in the lowered position in response to receiving operator indication signal S_{Operator} from overhead door operator 106. Operator indication signal S_{Operator} corresponds to a closed indication when overhead door 103 remains in the lowered position in response to receiving operator indication signal S_{Operator} from overhead door operator 106. In this way, operator indication signal S_{Operator} can correspond to open and close indications. In the raised position, vehicle 110 is capable of entering building 104 and, in the lowered position, vehicle 110 is restricted by overhead door 103 from entering building 104.

In this embodiment, access control system 100 includes a barrier controller 120 which is operatively coupled to overhead door operator 106. Overhead door operator 106 moves overhead door 103 between the raised and lowered positions in response to a controller indication signal S_{Controller} (FIG. 1c) provided by barrier controller 120. It should be noted that operator indication signal S_{Operator} is provided to overhead door 103 in response to overhead door operator 106 receiving controller indication signal S_{Controller} from barrier controller 120.

In one situation, overhead door operator 106 moves overhead door 103 from the lowered position to the raised position in response to receiving controller indication signal S_{Controller} from barrier controller 120. Controller indication signal S_{Controller} corresponds to the open indication when overhead door operator 106 moves overhead door 103 from the lowered position to the raised position in response to receiving controller indication signal S_{Controller} from barrier controller 120.

In another situation, overhead door operator 106 does not move overhead door 103 from the lowered position to the raised position in response to receiving controller indication signal S_{Controller} from barrier controller 120. Controller indication signal S_{Controller} corresponds to the closed indication when overhead door operator 106 does not move overhead door 103 from the lowered position to the raised position in response to receiving controller indication signal S_{Controller} from barrier controller 120.

In this embodiment, access control system 100 includes an access database 105 in communication with barrier controller 120. Access database 105 includes a database of information which is used to determine controller indication signal S_{Controller} and operator indication signal S_{Operator}, as will be discussed in more detail below. Access database 105 provides a database signal S_{Database} to barrier controller 120 which corresponds to the information used to determine controller indication signal S_{Controller} and operator indication signal S_{Operator}. In particular, the information of access database 105 is used to determine if controller indication signal S_{Controller} and operator indication signal S_{Operator} will correspond to the open or closed conditions discussed above.

In this embodiment, controller indication signal S_{Controller} is provided by barrier controller 120 in response to a vehicle indication signal S_{Vehicle}, which is provided by vehicle 110, and in response to database signal S_{Database}. Vehicle indication signal S_{Vehicle} flows from vehicle 110 to barrier controller 120 in response to a query signal S_{Query}. In some embodiments, access control system 100 includes a vehicle proximity detector loop (not shown), which detects the approach of vehicle 110 to barrier controller 120, as shown in FIG. 1a. Barrier controller 120 flows query signal S_{Query} to vehicle 110 in response to an approach indication from the vehicle proximity detector loop. Query signal S_{Query} flows from barrier controller 120 to vehicle 110. Vehicle indication signal S_{Vehicle} and query signal S_{Query} can flow between vehicle 110 and barrier controller 120 in many different ways, one of which will be discussed in more detail presently.

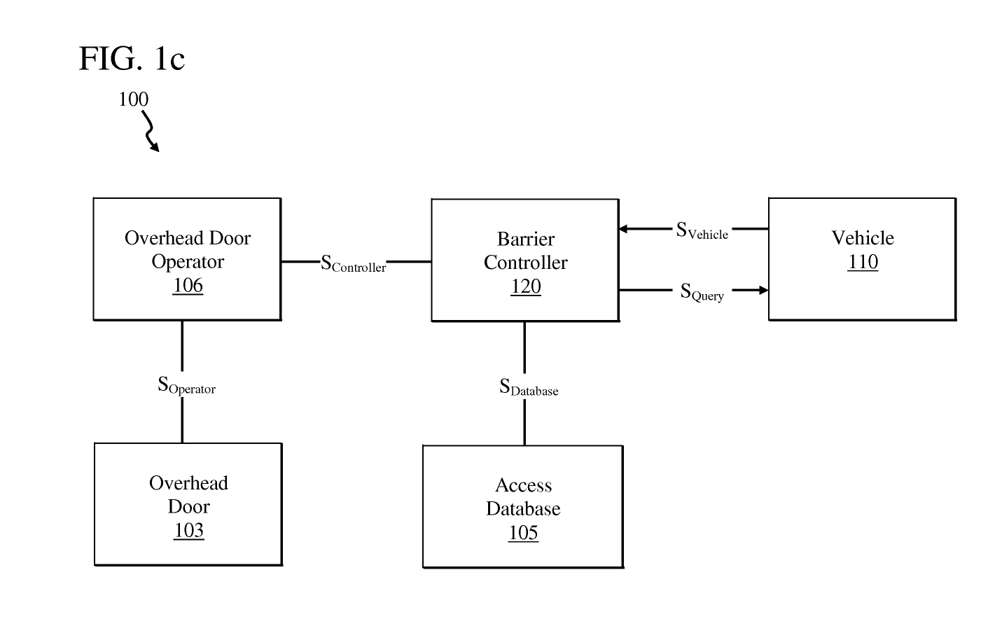

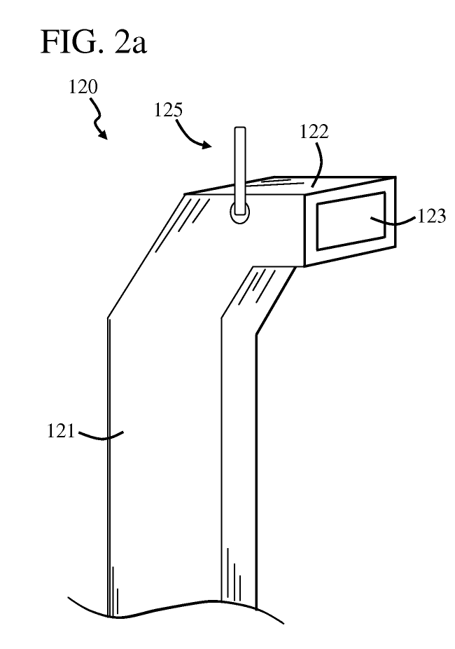

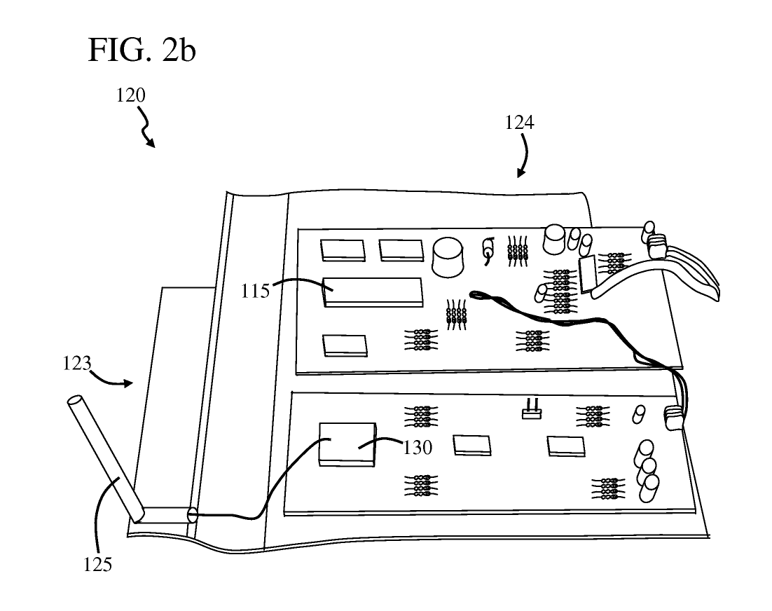

FIG. 2a is a perspective view of the one embodiment of barrier controller 120. In this embodiment, barrier controller 120 includes a barrier controller display 123 which is carried by a barrier controller body 121. Barrier controller body 121 includes a barrier controller neck 122, through which barrier controller display 123 extends. Barrier controller body 121 body holds barrier controller display 123 at a position in which it is convenient for a person operating vehicle 110 to see.

In this embodiment, barrier controller 120 includes a barrier controller antenna 125, which is operatively coupled to a barrier controller circuit board 124 (FIGS. 2b and 2c). Barrier controller antenna 125 can be positioned at many different locations. For example, in some embodiments, barrier controller antenna 124 is positioned within barrier controller body 121. In some embodiments, barrier controller antenna 124 is positioned within barrier controller neck 122. In this embodiment, however, barrier controller antenna 124 extends through barrier controller neck 122, as shown in FIG. 2a.

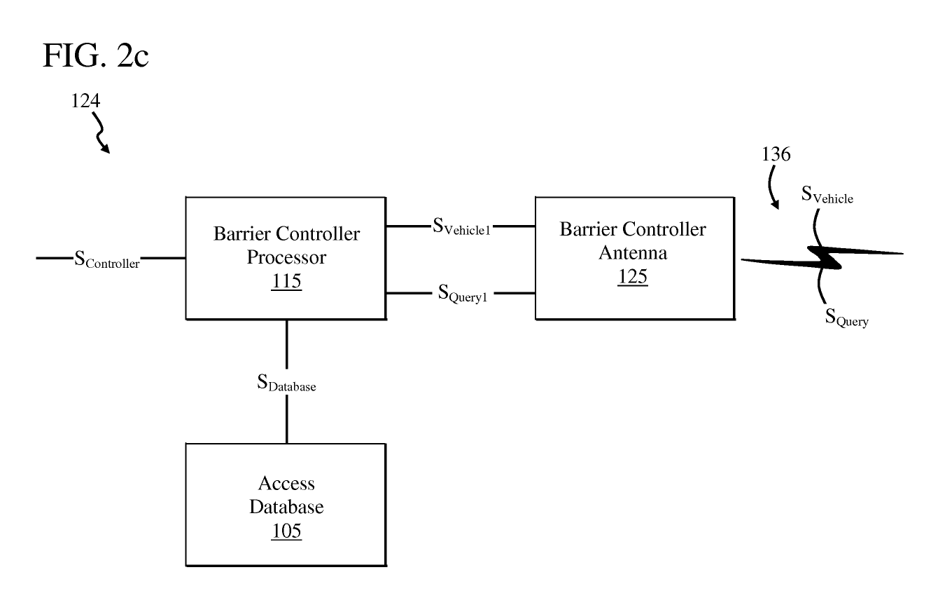

In this embodiment, vehicle indication signal S_{Vehicle} flows between vehicle 110 and barrier controller 120 through barrier controller antenna 125. Hence, vehicle indication signal S_{Vehicle} is a wireless signal which is capable of propagating without a wire. Other signals are wired signals which are not capable of propagating without a wire. Vehicle 110 can flow vehicle indication signal S_{Vehicle} to barrier controller 120 in many different ways, one of which will be discussed in more detail below with FIG. 3. Barrier controller 120 can flow query signal S_{Query} to vehicle 110 in many different ways, one of which will be discussed in more detail presently.

FIG. 2b is a perspective view of one embodiment of barrier controller circuit board 124, and FIG. 2c is a block diagram of one embodiment of barrier controller circuit board 124. In this embodiment, query signal S_{Query} flows between vehicle 110 and barrier controller 120 through barrier controller antenna 125. Hence, query signal S_{Query} is a wireless signal which is capable of propagating without a wire. In this embodiment, barrier controller circuit board 124 includes a barrier controller processor 115 operatively coupled to barrier controller antenna 125 and barrier controller display 123. Barrier controller processor 115 is in communication with access database 105 and receives database signal S_{Database} therefrom.

In one mode of operation, barrier controller circuit board flows a query signal S_{Query1} to barrier controller antenna 125, and barrier controller antenna 125 flows a query signal S_{Query} to vehicle 110 in response. Query signal S_{Query} and query signal S_{Query1} are wireless and wired signals, respectively. Query signal S_{Query} is a wireless signal which corresponds to wired signal query signal S_{Query1}.

In this mode of operation, vehicle 110 receives query signal S_{Query} and provides vehicle indication signal S_{Vehicle} in response. In this mode of operation, barrier controller circuit board 124 receives vehicle indication signal S_{Vehicle} through barrier controller antenna 125 and flows it to barrier controller processor 115 as a vehicle indication signal S_{Vehicle1}. Vehicle indication signal S_{Vehicle} is a wireless signal which corresponds to wired signal vehicle indication signal S_{Vehicle1}. Barrier controller processor 115 receives wired vehicle indication signal S_{Vehicle1} and database signal S_{Database} from barrier controller antenna 125 and access database 105, respectively.

Barrier controller processor 115 processes wired vehicle indication signal S_{Vehicle1} and database signal S_{Database} with barrier controller processor 115 and provides controller indication signal S_{Controller} in response. In particular, barrier controller processor 115 processes wired vehicle indication signal S_{Vehicle1} and the information of access database 105 to determine if controller indication signal S_{Controller} and operator indication signal S_{Operator} will correspond to the open or closed conditions discussed above. In this way, access control system 100 determines if vehicle 110 is allowed to access the area.

In this embodiment, barrier controller circuit board 124 displays information corresponding to vehicle indication signal S_{Vehicle} and/or database signal S_{Database} with barrier controller display 123. Vehicle 110 can provide vehicle indication signal S_{Vehicle} in many different ways, one of which will be discussed in more detail presently.

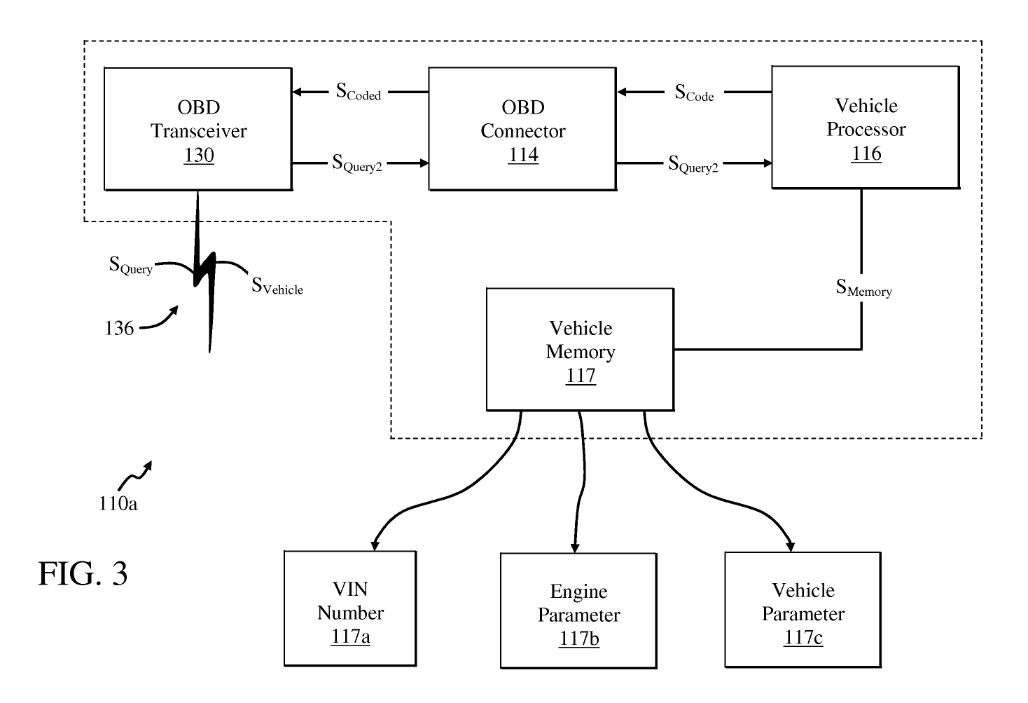

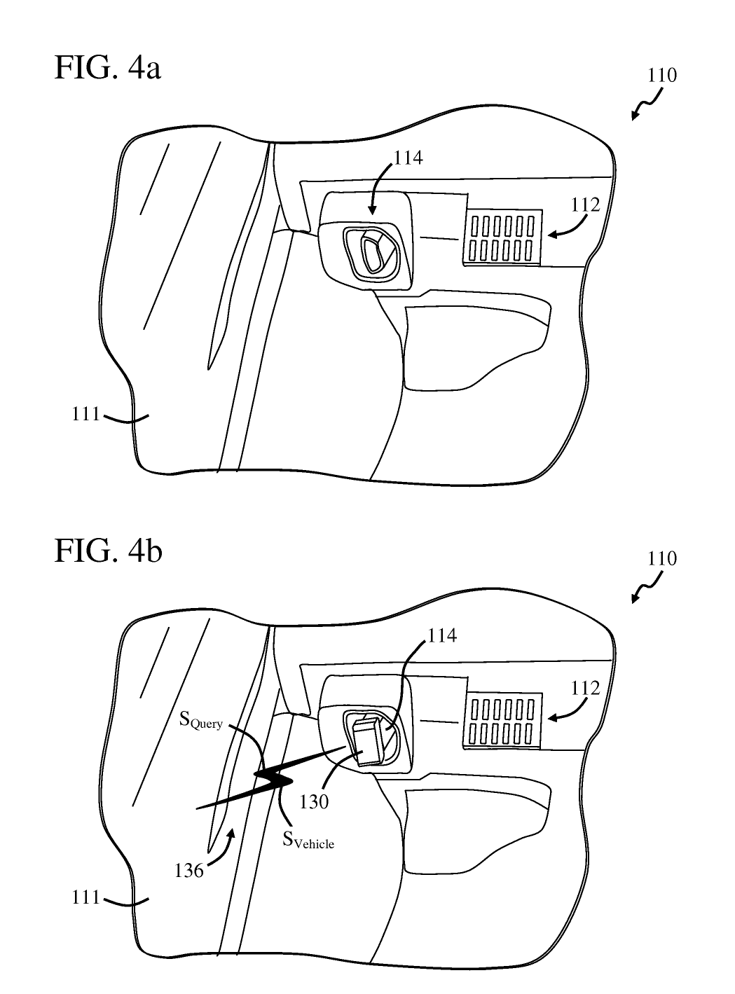

FIG. 3 is a block diagram of one embodiment of an electrical system 110a of vehicle 110. In this embodiment, vehicle 100 includes an on-board diagnostics (OBD) transceiver 130 connected to an OBD connector 114. More information regarding OBD connector 114 is provided below with FIGS. 4a, 4b, 5a, 5b, 7a and 7b. It should be noted that OBD connector 114 is typically operated with firmware that is processed by a software program.

In some embodiments, the software program is capable of determining a predetermined identifier associated with OBD transceiver 130. The predetermined identifier associated with OBD transceiver 130 is stored with memory (not shown) of OBD transceiver 130. One type of predetermined identifier that is associated with OBD transceiver 130 is referred to as a Media Access Control (MAC) address. A typical MAC address includes a predetermined number of characters, such as ASCI characters. For example, some MAC addresses correspond to 32 ASCI characters which uniquely identify the OBD transceiver. In this way, barrier controller 120 can determine which OBD transceiver 130 it is in communication with.

In this embodiment, OBD transceiver 130 includes a ZigBee Wireless Vehicle Logger manufactured by NexTek, Inc. of Reading, Pa. The ZigBee Wireless Vehicle Logger uses the IEEE 802.15.4 wireless networking protocol. It should be noted, however, that there are many manufacturers of wireless systems for querying a vehicle's OBD-II interface that use a range of different wireless standards.

In this embodiment, OBD transceiver 130 establishes a wireless link 136 with barrier controller antenna 125, wherein vehicle indication signal S_{Vehicle} and query signal S_{Query} flow wirelessly through wireless link 136. In this way, vehicle 110 and access control system 100 are in communication with each other through a wireless link.

In this embodiment, OBD connector 114 is in communication with a vehicle processor 116 so that query signal S_{Query2} and a code indication signal S_{Code} flow therebetween. Query signal S_{Query2} is a wired signal which corresponds to wireless signal query signal S_{Query}. Further, code indication signal S_{Code} is a wired signal which corresponds to a code of vehicle 110. As will be discussed in more detail below, the code of vehicle 110 is used by OBD transceiver 130 to form vehicle indication signal S_{Vehicle}. It should be noted that the firmware of OBD transceiver is capable of communicating with vehicle processor 116.

In this embodiment, vehicle processor 116 is in communication with vehicle memory 117. Vehicle processor 116 and vehicle memory 117 are typically included with an on-board computer of vehicle 110. Vehicle memory 117 can be of many different types. In some embodiments, vehicle memory 117 is read only memory (ROM) and, in other embodiments, vehicle memory 117 is FLASH memory. More information regarding OBD connector 114, vehicle processor 116 and vehicle memory 117 can be found in U.S. Pat. Nos. 6,529,808, 6,636,790, 6,732,031, 6,807,469 and 6,816,760, as well as U.S. Provisional No. 20080082221, the contents of all of which are incorporated by reference as though fully set forth herein.

It should be noted that vehicle memory 117 is capable of storing many different types of information. For example, in some embodiments, vehicle memory 117 stores information 117a corresponding to the vehicle identification number (VIN) of vehicle 110. In some embodiments, vehicle memory 117 stores information 117b corresponding to an engine parameter of vehicle 110. The engine parameter can be of many different types of parameters, such as the type of engine, year of manufacture, etc. In some embodiments, vehicle memory 117 stores information 117c corresponding to a vehicle parameter of vehicle 110. The vehicle parameter can be of many different types of parameters, such as the type of vehicle, calibration setting for a sensor of vehicle 110, year of manufacture, etc. The information of vehicle memory 117 is used to form the code used by OBD transceiver 130 to form vehicle indication signal S_{Vehicle}.

It should also be noted that the information of vehicle memory 117 can be written to memory 117 so it corresponds with information of access database 105. The information written to vehicle memory 117 can be generated using a random number generator, so that the information corresponds to a random number key. The random number key is stored with access database 105 and vehicle memory 117. In some situations, the random number is combined with information corresponding to vehicle 110, such as information 117a, 117b and/or 117c, to provide a random vehicle key. The random vehicle key is stored with access database 105 and vehicle memory 117.

In this embodiment, a memory signal S_{Memory} flows between vehicle memory 117 and vehicle processor 116. Memory signal S_{Memory} typically includes the information discussed above. Vehicle processor 116 receives memory signal S_{Memory} from vehicle memory 117 and provides code indication signal S_{Code} in response. Code indication signal S_{Code} is flowed to OBD transceiver 130 through OBD connector 114, as discussed above.

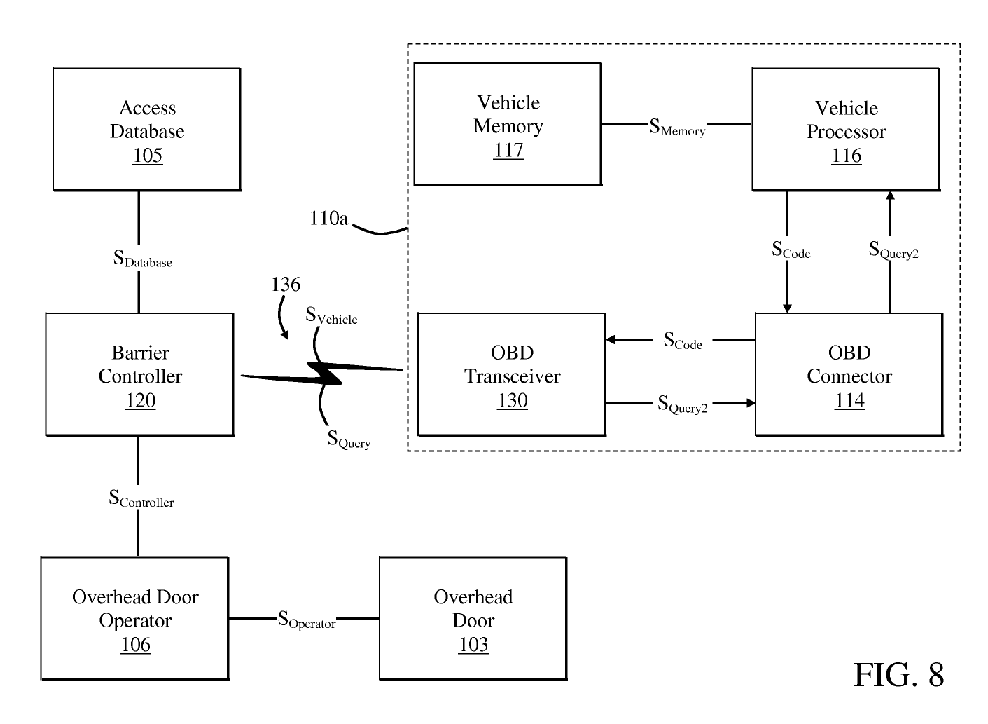

In this embodiment, OBD transceiver 130 receives code indication signal S_{Code} and provides vehicle indication signal S_{Vehicle} as a wireless signal in response. Vehicle indication signal S_{Vehicle} is flowed to barrier controller 120 through wireless communication link 136. The flow of vehicle indication signal S_{Vehicle} and query signal S_{Query} through communication link 136, and the formation of vehicle indication signal S_{Vehicle} with code indication signal S_{Code}, will be discussed in more detail with FIG. 8.

FIG. 4a is a perspective view of an interior of vehicle 100, which shows OBD connector 114 positioned proximate to a vehicle door 111 and fuse panel 112. It should be noted that vehicle door 111 is shown in FIG. 1a.

FIG. 4b is a perspective view of an interior of vehicle 100, which shows OBD connector 114 positioned proximate to vehicle door 111 and fuse panel 112. In this embodiment, OBD transceiver 130 is operatively coupled to OBD connector 114. OBD transceiver 130 is operatively coupled to OBD connector 114 so it is in communication with vehicle processor 116. As shown in FIG. 4b, OBD transceiver 130 establishes wireless communication link 136 so that vehicle indication signal S_{Vehicle} and query signal S_{Query} can flow therethrough.

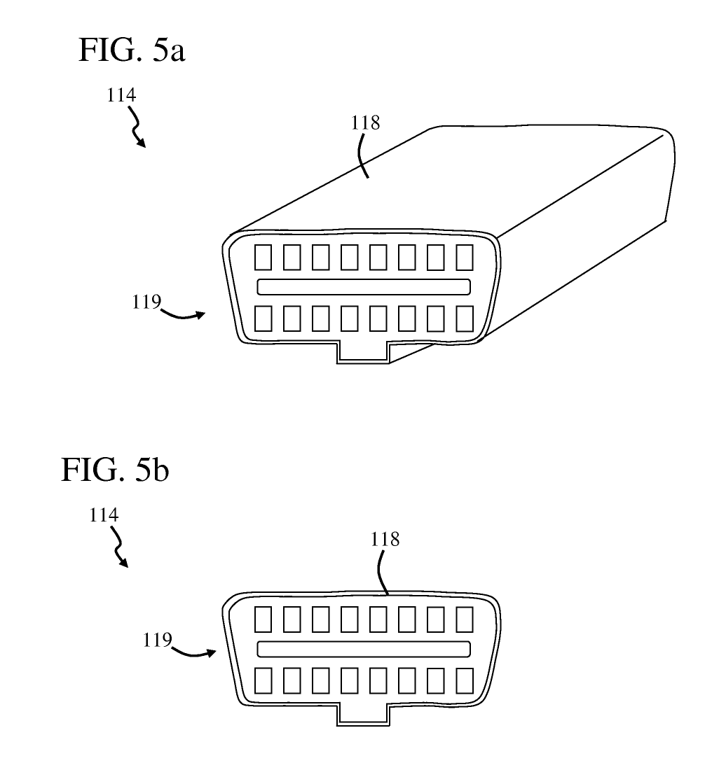

FIGS. 5a and 5b are perspective and end views, respectively, of OBD connector 114. In this embodiment, OBD connector 114 includes a plurality of connectors 119, which are arranged in a well-known manner.

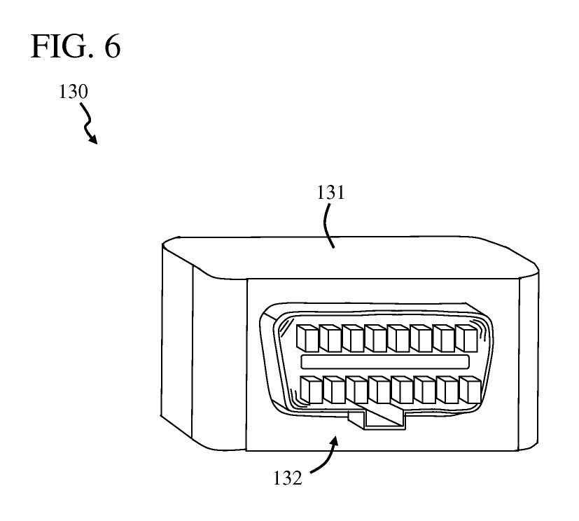

FIG. 6 is a perspective view of OBD transceiver 130, wherein OBD transceiver 130 includes a plurality of connectors 132, which are arranged so that they can be engaged with corresponding connectors 119 of OBD connector 114. In this way, OBD connector 114 and OBD transceiver 130 are operatively coupled together. OBD connector 114 and OBD transceiver 130 are operatively coupled together so that signals can flow therebetween.

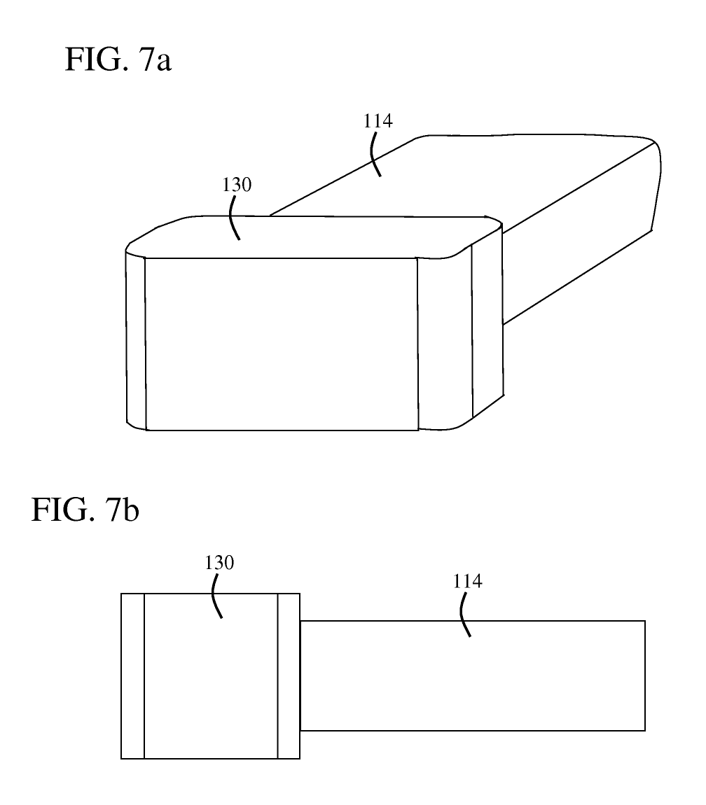

FIGS. 7a and 7b are perspective and side views, respectively, of OBD transceiver 130 operatively connected to OBD connector 114. It should be noted that OBD transceiver 130 and OBD connector 114 are shown operatively connected together in FIG. 4b.

FIG. 8 is a block diagram of electrical system 110a of vehicle 110 in communication with barrier controller 120 through wireless link 136. In this embodiment, wireless link 136 is established between OBD transceiver 130 and barrier controller antenna 125, as discussed in more detail above.

In operation, vehicle 110 approaches barrier controller 120, as shown in FIG. 1a, and barrier controller 120 flows query signal S_{Query} to vehicle 110 in response. In particular, barrier controller 120 provides query signal S_{Query} to OBD transceiver 130. OBD transceiver 130 receives query signal S_{Query} and provides a query signal S_{Query1} to vehicle processor 116 through OBD connector 114 in response. Vehicle processor 116 receives query signal S_{Query1} and reads the information stored with vehicle memory 117.

In a first situation, the information stored with vehicle memory 117 that is read by vehicle processor 116 corresponds to information 117a. As mentioned above, information 117a corresponds to the VIN of vehicle 110. Vehicle processor 116 provides code indication signal S_{Code} to OBD transceiver 130 through OBD connector 114, wherein code indication signal S_{Code} corresponds to information 117a. In this particular situation, code indication signal S_{Code} corresponds to the VIN number of vehicle 110.

OBD transceiver 130 provides vehicle indication signal S_{Vehicle} in response to receiving code indication signal S_{Code}, wherein vehicle indication signal S_{Vehicle} corresponds to code indication signal S_{Code}. In this way, barrier controller 120 receives information corresponding to the identity of vehicle 110. In some examples, vehicle indication signal S_{Vehicle} corresponds to code indication signal S_{Code} and the predetermined identifier of OBD transceiver 130. In this way, barrier controller 120 receives information corresponding to the identity of vehicle 110 and OBD transceiver 130.

Barrier controller 120 receives vehicle indication signal S_{Vehicle} and communicates with access database 105 to determine if vehicle indication signal S_{Vehicle} is stored with access database 105. Access database 105 provides database signal S_{Database} to barrier controller 120 in response to the determination of vehicle indication signal S_{Vehicle} being stored with access database 105.

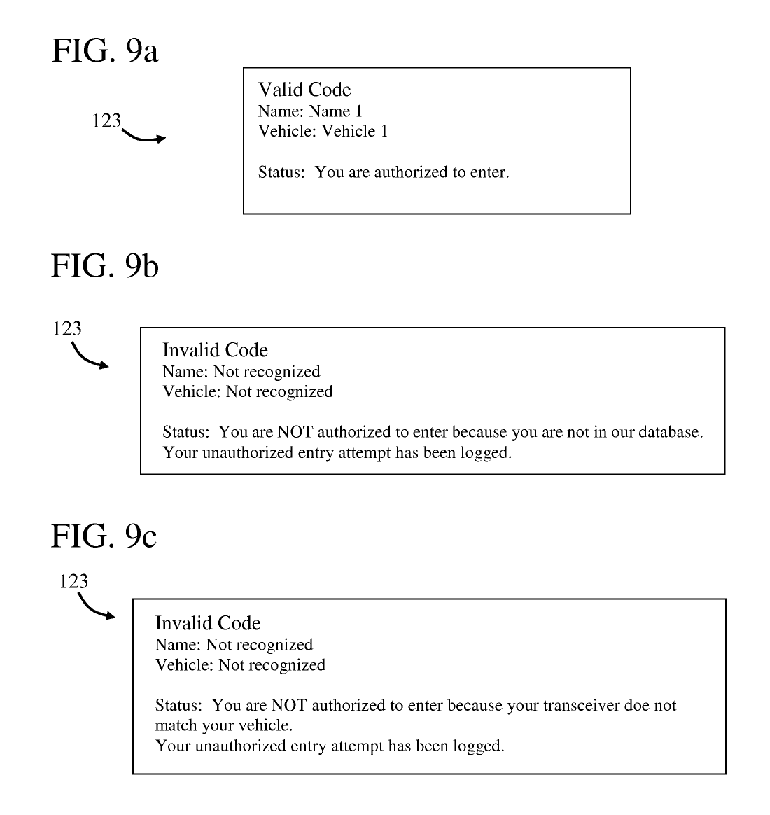

Controller indication signal S_{Controller} corresponds to the open indication when barrier controller 120 determines that vehicle indication signal S_{Vehicle} is stored with access database 105. As mentioned above, overhead door operator 106 moves overhead door 103 from the lowered position to the raised position in response to controller indication signal S_{Controller} corresponding to the open condition. Display 123 displays an indication that overhead door operator is in the open condition, as shown in FIG. 9a, and the entry attempt is authorized.

Controller indication signal S_{Controller} corresponds to the closed indication when barrier controller 120 determines that vehicle indication signal S_{Vehicle} is not stored with access database 105. As mentioned above, overhead door operator 106 does not move overhead door 103 from the lowered position to the raised position in response to controller indication signal S_{Controller} corresponding to the close condition. Display 123 displays an indication that overhead door operator is in the closed condition, as shown in FIG. 9b, and the entry attempt is unauthorized.

In some embodiments, access control system 100 stores vehicle indication signal S_{Vehicle}. Access control system 100 can store vehicle indication signal S_{Vehicle} in many different ways. For example, access control system 100 can store vehicle indication signal S_{Vehicle} with access database 105 and with memory of barrier controller circuit board 124. Vehicle indication signal S_{Vehicle} can be stored by access control system 100 for many different reasons, such as to log vehicles that pass through access control system 100. Vehicle indication signal S_{Vehicle} can also be stored by access control system 100 to log failed attempts to pass through access control system 100. It should be noted that the date, time, etc. that barrier controller 120 receives vehicle indication signal S_{Vehicle} can also be stored with vehicle indication signal S_{Vehicle}, if desired.

In a second situation, the information stored with vehicle memory 117 that is read by vehicle processor 116 corresponds to information 117b. As mentioned above, information 117a corresponds to an engine parameter of vehicle 110. Vehicle processor 116 provides code indication signal S_{Code} to OBD transceiver 130 through OBD connector 114, wherein code indication signal S_{Code} corresponds to information 117b. In this particular situation, code indication signal S_{Code} corresponds to the engine parameter of vehicle 110.

OBD transceiver 130 provides vehicle indication signal S_{Vehicle} in response to receiving code indication signal S_{Code}, wherein vehicle indication signal S_{Vehicle} corresponds to code indication signal S_{Code}. In this way, barrier controller 120 receives information corresponding to the identity of vehicle 110. In some examples, vehicle indication signal S_{Vehicle} corresponds to code indication signal S_{Code} and the predetermined identifier of OBD transceiver 130. In this way, barrier controller 120 receives information corresponding to the identity of vehicle 110 and OBD transceiver 130.

Barrier controller 120 receives vehicle indication signal S_{Vehicle} and communicates with access database 105 to determine if vehicle indication signal S_{Vehicle} is stored with access database 105. Access database 105 provides database signal S_{Database} to barrier controller 120 in response to the determination of vehicle indication signal S_{Vehicle} being stored with access database 105.

Controller indication signal S_{Controller} corresponds to the open indication when barrier controller 120 determines that vehicle indication signal S_{Vehicle} is stored with access database 105. As mentioned above, overhead door operator 106 moves overhead door 103 from the lowered position to the raised position in response to controller indication signal S_{Controller} corresponding to the open condition. Display 123 displays an indication that overhead door operator is in the open condition, as shown in FIG. 9a, and the entry attempt is authorized.

Controller indication signal S_{Controller} corresponds to the closed indication when barrier controller 120 determines that vehicle indication signal S_{Vehicle} is not stored with access database 105. As mentioned above, overhead door operator 106 does not move overhead door 103 from the lowered position to the raised position in response to controller indication signal S_{Controller} corresponding to the close condition. In this way, access control system 100 controls the access of vehicle 110 in response to an engine parameter of vehicle 110. Display 123 displays an indication that overhead door operator is in the closed condition, as shown in FIG. 9b, and the entry attempt is unauthorized.

In a third situation, the information stored with vehicle memory 117 that is read by vehicle processor 116 corresponds to information 117c. As mentioned above, information 117a corresponds to a vehicle parameter of vehicle 110. Vehicle processor 116 provides code indication signal S_{Code} to OBD transceiver 130 through OBD connector 114, wherein code indication signal S_{Code} corresponds to information 117c. In this particular situation, code indication signal S_{Code} corresponds to the engine parameter of vehicle 110.

OBD transceiver 130 provides vehicle indication signal S_{Vehicle} in response to receiving code indication signal S_{Code}, wherein vehicle indication signal S_{Vehicle} corresponds to code indication signal S_{Code}. In this way, barrier controller 120 receives information corresponding to the identity of vehicle 110. In some examples, vehicle indication signal S_{Vehicle} corresponds to code indication signal S_{Code} and the predetermined identifier of OBD transceiver 130. In this way, barrier controller 120 receives information corresponding to the identity of vehicle 110 and OBD transceiver 130.

Barrier controller 120 receives vehicle indication signal S_{Vehicle} and communicates with access database 105 to determine if vehicle indication signal S_{Vehicle} is stored with access database 105. Access database 105 provides database signal S_{Database} to barrier controller 120 in response to the determination of vehicle indication signal S_{Vehicle} being stored with access database 105.

Controller indication signal S_{Controller} corresponds to the open indication when barrier controller 120 determines that vehicle indication signal S_{Vehicle} is stored with access database 105. As mentioned above, overhead door operator 106 moves overhead door 103 from the lowered position to the raised position in response to controller indication signal S_{controller} corresponding to the open condition. Display 123 displays an indication that overhead door operator is in the open condition, as shown in FIG. 9a, and the entry attempt is authorized.

Controller indication signal S_{Controller} corresponds to the closed indication when barrier controller 120 determines that vehicle indication signal S_{Vehicle} is not stored with access database 105. As mentioned above, overhead door operator 106 does not move overhead door 103 from the lowered position to the raised position in response to controller indication signal S_{Controller} corresponding to the close condition. Display 123 displays an indication that overhead door operator is in the closed condition, as shown in FIG. 9b, and the entry attempt is unauthorized. In this way, access control system 100 controls the access of vehicle 110 in response to a vehicle parameter of vehicle 110.

It should be noted that, in some situations, a person may attempt to make an unauthorized entry through access control system 100 by connecting OBD connector 130 to an OBD connector of an unauthorized vehicle that is not vehicle 110. For example, the person can disconnect OBD connector 130 from OBD connector 114 of vehicle 110, and connect OBD connector 130 to the unauthorized vehicle.

In this situation, barrier controller 120 flows query signal S_{Query} to the unauthorized vehicle in response to the unauthorized vehicle approaching barrier controller 120. In particular, barrier controller 120 provides query signal S_{Query} to OBD transceiver 130. OBD transceiver 130 receives query signal S_{Query} and provides a query signal S_{Query1} to vehicle processor 116 through OBD connector 114 in response. Vehicle processor 116 receives query signal S_{Query1} and reads the information stored with vehicle memory 117.

In a first situation, the information stored with vehicle memory 117 that is read by vehicle processor 116 corresponds to information 117a. As mentioned above, information 117a corresponds to the VIN of the unauthorized vehicle. Vehicle processor 116 provides code indication signal S_{Code} to OBD transceiver 130 through OBD connector 114, wherein code indication signal S_{Code} corresponds to information 117a. In this particular situation, code indication signal S_{Code} corresponds to the VIN number of the unauthorized vehicle.

OBD transceiver 130 provides vehicle indication signal S_{Vehicle} in response to receiving code indication signal S_{Code}, wherein vehicle indication signal S_{Vehicle} corresponds to code indication signal S_{Code}. In this way, barrier controller 120 receives information corresponding to the identity of the unauthorized vehicle. In some examples, vehicle indication signal S_{Vehicle} corresponds to code indication signal S_{Code} and the predetermined identifier of OBD transceiver 130. In this way, barrier controller 120 receives information corresponding to the identity of the unauthorized vehicle and OBD transceiver 130.

Barrier controller 120 receives vehicle indication signal S_{Vehicle} and communicates with access database 105 to determine if vehicle indication signal S_{Vehicle} is stored with access database 105. Access database 105 provides database signal S_{Database} to barrier controller 120 in response to the determination of vehicle indication signal S_{Vehicle} being stored with access database 105.

Controller indication signal S_{Controller} will not correspond to the open indication because barrier controller 120 will determine that vehicle indication signal S_{Vehicle} is not stored with access database 105. Barrier controller 120 will determine that vehicle indication signal S_{Vehicle} is not stored with access database 105 because the VIN information of the unauthorized vehicle will not be stored with access database 105. Hence, overhead door operator 106 will not move overhead door 103 from the lowered position to the raised position in because controller indication signal S_{Controller} will not correspond to the open condition. Display 123 displays an indication that overhead door operator is in the closed condition, as shown in FIG. 9c, and the entry attempt is unauthorized.

Controller indication signal S_{Controller} corresponds to the closed indication when barrier controller 120 determines that vehicle indication signal S_{Vehicle} is not stored with access database 105. As mentioned above, overhead door operator 106 does not move overhead door 103 from the lowered position to the raised position in response to controller indication signal S_{Controller} corresponding to the close condition. Display 123 displays an indication that overhead door operator is in the closed condition, as shown in FIG. 9c, and the entry attempt is unauthorized.

In some embodiments, access control system 100 stores vehicle indication signal S_{Vehicle}, which will correspond to the VIN of the unauthorized vehicle. In some embodiments, access control system 100 stores the predetermined identifier of OBD transceiver 130. Storing the VIN of the unauthorized vehicle and the predetermined identifier of OBD transceiver 130 facilitates the ability to determine who attempted the unauthorized entry, and who should have OBD transceiver 130.

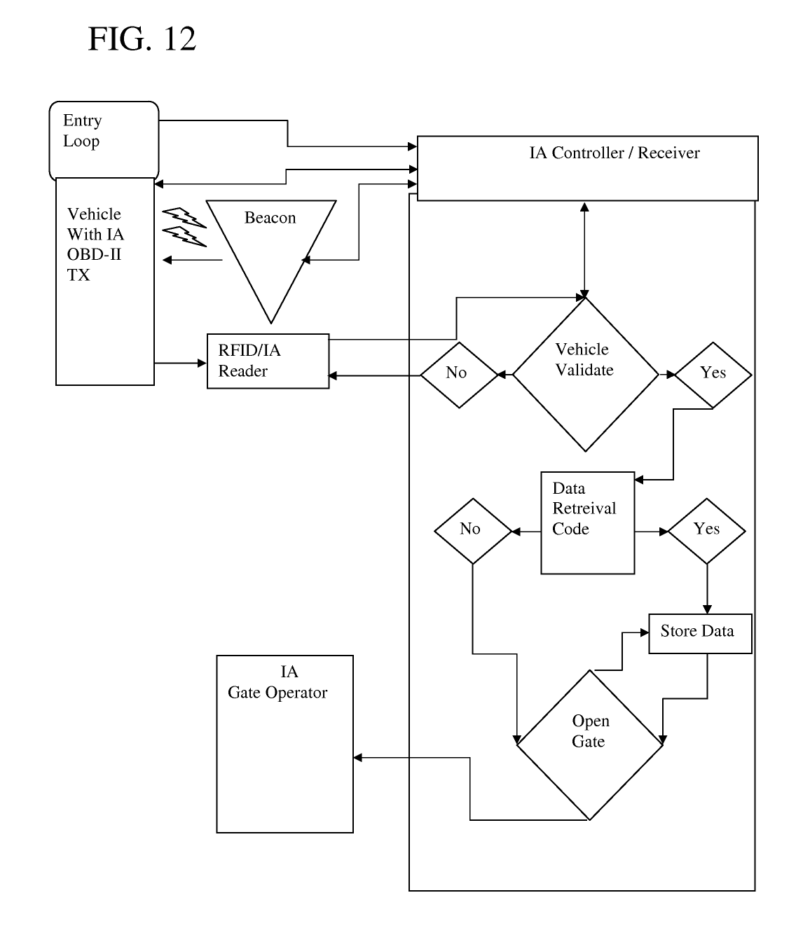

FIG. 12 is a flow diagram of one embodiment of the operation of access control system 100. It should be noted that access control system 100 can provide other types of access control. For example, access control system 100 can include an operator identification system, such as a keypad, card reader, retinal scanner, etc., which require the operator of vehicle 110 to provide an input which corresponds to the operator's identity. Access control system 100 can compare the identity of the operator to information associated with the vehicle to ensure that they match before access control system 100 provides access. The identity of the operator of vehicle 110 can be stored with access control system 100. Examples of operator identification systems are disclosed in U.S. Pat. Nos. 4,816,658, 4,975,969, 6,107,930, 6,215,405 6,335,688, the contents of which are incorporated by reference as though fully set forth herein.

The operator identification system provides an identification signal S_{ID} to barrier controller 120. The barrier is restricted from moving from a closed condition to an open condition in response to an indication that the vehicle indication signal S_{Vehicle} does not correspond to information of the access database and in response to an indication that the identification signal S_{ID} does not correspond to information of access database 105.

It should be noted that access control system 100 can include a surveillance system that provides surveillance. Examples of systems which provide surveillance and can be included with access control system 100 include systems disclosed in U.S. Pat. Nos. 6,433,706, 6,650,765, and 7,339,495, the contents of which are incorporated by reference as though fully set forth herein. Some surveillance systems read the license plate of vehicle 110 so that the license plate number of vehicle 110 can be stored with access control system 100. License plate numbers can be stored with access database 105 and compared to vehicles attempting to gain access through access control system 100. The surveillance system provides a surveillance signal S_{Surveillance} to barrier controller 120.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

1. An access control system, comprising:
an access database;
barrier controller in communication with the access database; and
a vehicle with an electrical system having an OBD transceiver in communication with an on-board computer through an OBD connector;
wherein the OBD transceiver provides a vehicle indication signal S_{Vehicle} to the barrier controller in response to receiving a query signal S_{Query} from the barrier controller.

2. The system of claim 1, wherein the barrier controller is operatively coupled to a barrier.

3. The system of claim 1, wherein the barrier moves from a closed condition to an open condition in response to an indication that the vehicle indication signal S_{Vehicle} corresponds to information of the access database.

4. The system of claim 1, wherein the barrier is restricted from moving from a closed condition to an open condition in response to an indication that the vehicle indication signal S_{Vehicle} does not correspond to information of the access database.

5. The system of claim 1, wherein the vehicle indication signal S_{Vehicle} corresponds to a vehicle identification number of the vehicle.

6. The system of claim 5, wherein the barrier controller stores the vehicle identification number of the vehicle.

7. The system of claim 1, wherein the vehicle indication signal S_{Vehicle} corresponds to a vehicle identification number of the vehicle and a predetermined identifier associated with the OBD transceiver.

8. The system of claim 7, wherein the barrier controller stores the vehicle identification number of the vehicle and the predetermined identifier associated with the OBD transceiver.

9. The system of claim 1, wherein the vehicle indication signal S_{Vehicle} corresponds to a random number key stored with the vehicle.

10. The system of claim 1, wherein the vehicle indication signal S_{Vehicle} corresponds to a random vehicle key stored with the vehicle.

11. The system of claim 1, wherein the barrier controller stores the vehicle indication signal S_{Vehicle}.

12. The system of claim 1, wherein the barrier controller establishes a wireless communication link with the OBD transceiver.

13. The system of claim 12, wherein the barrier controller is operatively coupled to a barrier operator.

14. The system of claim 1, further including an operator identification system in communication with the barrier controller, wherein the operator identification system provides an identification signal S_{ID}.

15. The system of claim 14, wherein the barrier is restricted from moving from a closed condition to an open condition in response to an indication that the vehicle indication signal S_{Vehicle} does not correspond to information of the access database and in response to an indication that the identification signal S_{ID} does not correspond to identification information of the access database.

16. The system of claim 1, further including a surveillance system in communication with the barrier controller, wherein the operator identification system provides a surveillance signal S_{Surveillance}.

17. The system of claim 16, wherein the barrier is restricted from moving from a closed condition to an open condition in response to an indication that the vehicle indication signal S_{Vehicle} does not correspond to information of the access database and in response to an indication that the surveillance signal S_{Surveillance} does not correspond to surveillance information of the access database.
